(19) United States
(12) Patent Application Publication
(10) Pub. No.: US 2022/0404747 A1
(43) Pub. Date: Dec. 22, 2022

(54) FIXING DEVICE AND IMAGE FORMING APPARATUS

(71) Applicant: KYOCERA Document Solutions Inc., Osaka (JP)

(72) Inventors: Tatsuya YAMANAKA, Osaka-shi (JP); Masahiro UENO, Osaka-shi (JP)

(73) Assignee: KYOCERA Document Solutions Inc., Osaka (JP)

(21) Appl. No.: 17/807,333

(22) Filed: Jun. 16, 2022

(30) Foreign Application Priority Data
Jun. 18, 2021 (JP) 2021-101755

(51) Int. Cl. G03G 15/20

(52) U.S. Cl. CPC G03G 15/2053; G03G 2215/2035

(57) ABSTRACT

A fixing device includes an endless fixing belt, a heater, a pad, a stay and a pressing roller. The endless fixing belt rotates as a sheet is conveyed. The heater heats the fixing belt in a width direction. The pad comes into contact with an inner surface of the fixing belt in the width direction. The stay supports the pad inside the fixing belt. The pressing roller presses the fixing belt against the pad. The pad is made of metal.

### INCORPORATION BY REFERENCE

This application is based on and claims the benefit of priority from Japanese patent application No. 2021-101755 filed on Jun. 18, 2021, which is incorporated by reference in its entirety.

### BACKGROUND

The present disclosure relates to a fixing device and an image forming apparatus.

An electrophotographic type image forming apparatus such as a copying machine and a printer is provided with a fixing device which fixes an unfixed toner image on a sheet. In such a fixing device, a sheet is passed between a heated fixing belt and a pressing roller, and then the unfixed toner image is heat-fixed on the sheet. When the sheet is passed through the fixing device, heat is taken from the sheet passing region of the fixing belt to the sheet, and the temperature of the sheet passing region is lowered to increase a temperature difference between the sheet passing region and the non-sheet passing region. As a result, the sheet may curl. Therefore, there has been proposed a fixing device for cooling the non-sheet passing region of the fixing belt by air flow.

However, in the fixing device described above, when the number of sheets to be processed increases and the temperature of the non-sheet passing region increases, it is necessary to increase the air volume and the wind velocity of the air flow. When the air volume and the wind velocity of the air flow increase, the power loss of the fixing device increases and the power consumption increases. Although it is possible to reduce the number of sheets to be processed, there is a problem that productivity of the sheets may be lowered.

### SUMMARY

In accordance with one aspect of the present disclosure, a fixing device includes an endless fixing belt, a heater, a pad, a stay and a pressing roller. The endless fixing belt rotates as a sheet is conveyed. The heater heats the fixing belt in a width direction. The pad comes into contact with an inner surface of the fixing belt in the width direction. The stay supports the pad inside the fixing belt. The pressing roller presses the fixing belt against the pad. The pad is made of metal.

In accordance with one aspect of the present disclosure, an image forming apparatus includes an image forming unit which forms a toner image on a sheet; and the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a view schematically showing a printer according to one embodiment of the present disclosure.

FIG. 2 is a sectional view schematically showing a fixing device according to the embodiment of the present disclosure.

FIG. 3 is a graph showing a relationship between a heat conductivity of a pad and a temperature of a fixing belt.

FIG. 4 is a graph showing a relationship between a contact area ratio of the pad and a temperature of the fixing belt.

FIG. 5 is a perspective view showing the pad and a stay in the embodiment of the present disclosure.

### DETAILED DESCRIPTION

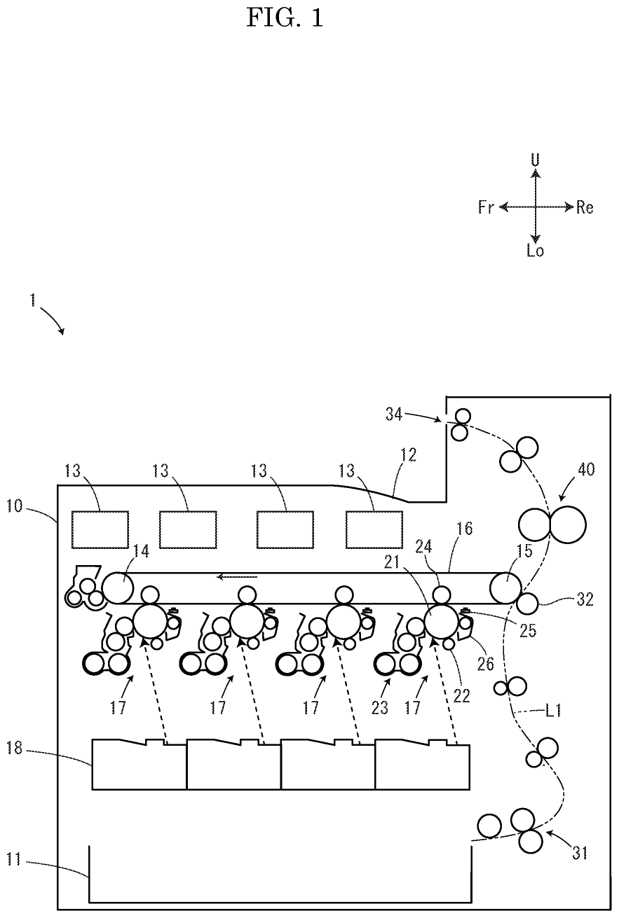

Hereinafter, with reference to the drawings, an image forming apparatus including a fixing device according to the present embodiment will be described. In the following description, a printer will be described as an example of the image forming apparatus. FIG. 1 is a view schematically showing the printer according to the present embodiment. Arrows Fr, Re, U and Lo appropriately attached to the respective drawings indicate the front, rear, upper, and lower sides of the printer, respectively.

As shown in FIG. 1, the printer 1 includes a box-shaped housing 10 in which various devices are housed. In the lower portion in the housing 10, a sheet feeding cassette 11 in which a bundle of sheets is set is housed, and in the upper portion in the housing 10, a sheet discharge tray 12 on which the sheets on which an image is formed is stacked is provided. Below the sheet discharge tray 12, a toner container 13 storing toner is detachably set for each color (for example, magenta, cyan, yellow and black) of the toner. Below the toner containers 13, an intermediate transfer belt 16 stretched around a pair of rollers 14 and 15 is provided.

Below the intermediate transfer belt 16, a plurality of image forming units 17 are arranged along a traveling direction of the intermediate transfer belt 6. Each image forming unit 17 includes a photosensitive drum 21 rotating in contact with the intermediate transfer belt 16. Around the photosensitive drum 21, a charger 22, a development device 23, a primary transfer roller 24, and a charge elimination device 25 and a cleaning device 26 are disposed in the order of the primary transfer process. To the cleaning device 26, a waste toner box (not shown) is connected. Each development device 23 is supplied with the toner from the corresponding toner container 13 through a supply passage (not shown). To the waste toner box, the waste toner is discharged from each cleaning device 26 through a discharge passage (not shown).

Below the image forming units 17, an exposure device 18 constituted by a laser scanning unit (LSU) is provided. In the side portion in the housing 10, a conveyance path L1 for the sheet from the sheet feeding cassette 11 to the sheet discharge tray 12 is formed by a plurality of rollers. A sheet feeding part 31 is provided on the upstream side (the lower side) of the conveyance path L1, and a secondary transfer roller 32 is provided on the side end of the intermediate transfer belt 16 on the downstream side of the sheet feeding part 31 on the conveyance path L1. A fixing device 40 is provided on the downstream side of the secondary transfer roller 32 on the conveyance path L, and a sheet discharge port 34 is provided on the downstream end side (the upper side) of the conveyance path L1.

At a time of an image forming operation in the printer 1, after the surface of the photosensitive drum 21 is charged by the charger 22, an electrostatic latent image is formed on the surface of the photosensitive drum 21 by laser light from the exposure device 18. Next, the development device 23 supplies the toner to the electrostatic latent image on the surface of the photosensitive drum 21 to form a toner image, and the toner image is primarily transferred from the surface of the photosensitive drum 21 to the surface of the intermediate transfer belt 16. A full-color toner image is formed on the surface of the intermediate transfer belt 16 by primary transferring the toner images of respective colors to the intermediate transfer belt 16 in each image forming unit 17. The charge and the waste toner remaining on the photosensitive drum 21 are removed by the charge elimination device 25 and the cleaning device 26.

On the other hand, the sheet is fed from the sheet feeding cassette 11 or the manual sheet feeding tray (not shown) by the sheet feeding part 31, and is conveyed toward the secondary transfer roller 32 in timing with the above image forming operation. The full-color toner image is secondarily transferred from the surface of the intermediate transfer belt 16 to the surface of the sheet by the secondary transfer roller 32, and the sheet on which the toner image is transferred is conveyed toward the fixing device 33 on the downstream side of the secondary transfer roller 32. In the fixing device 40, the toner image is fixed on the sheet, and the sheet on which the toner image is fixed is discharged through the sheet discharge port 34 on the sheet discharge tray 12. In the above manner, the toner image transferred to the sheet passes through the fixing device 40 to form the image on the surface of the sheet.

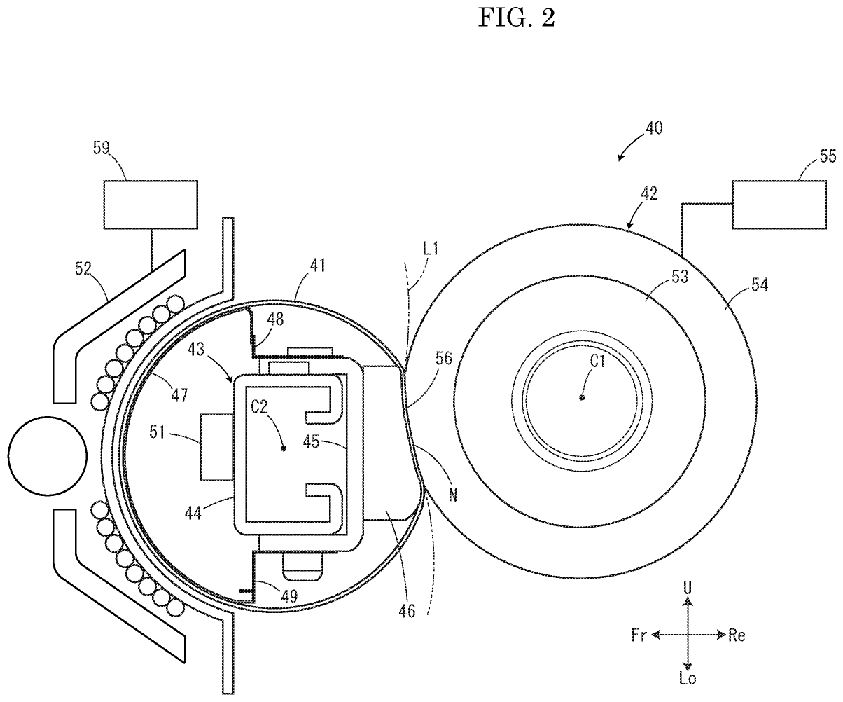

Next, with reference to FIG. 2, the fixing device 40 will be described. FIG. 2 is a sectional view schematically showing the fixing device 40 of the present embodiment. Although the fixing device 40 includes a fan which sends cool air to the fixing belt, the fan will not be described.

As shown in FIG. 2, the printer 1 (see FIG. 1) adopts the belt fixing type fixing device 40 which heat-fixes the unfixed toner image on the sheet using the endless fixing belt 41. The fixing device 40 includes the fixing belt 41 and a pressing roller 42 which face each other across the conveyance path L1 for the sheet, and a fixing nip area N is formed between the fixing belt 41 and the pressing roller 42. In the inner hollow space of the fixing belt 41, a metal stay 43 long in the width direction of the fixing belt 41 is provided. The stay 43 has a center frame 44 having an approximately rectangular C-shaped cross section and an auxiliary frame 45 having an approximately rectangular C-shaped cross section and covering the groove of the center frame 44.

A pad 46 in contact with the inner surface of the fixing belt 41 in the width direction is supported by the rear wall of the auxiliary frame 45. On the upper and lower walls of the auxiliary frame 45, a guide plate 47 having a substantially circular arc cross section for guiding a rotating of the fixing belt 41 is attached via support pieces 48 and 49. A temperature sensor 51 for measuring a temperature of the fixing belt 41 is attached to the front wall of the center frame 44. Outside the fixing belt 41, a heater 52 is provided on the side (the left side) opposite to the pressing roller 42. The heater 52 adopts an IH (Induction Heating) system, and heats the fixing belt 41 in the width direction.

The fixing belt 41 is formed in a cylindrical shape long in the width direction (a rotational axis direction), and is disposed so as to rotate as the sheet is conveyed. The fixing belt 41 is formed of a sliding layer, a base layer, an elastic layer and a release layer laminated from the inside to the outside, for example. The sliding layer is made of polyimide or fluorine-based resin or the like, the base layer is made of nickel, copper or the like, the elastic layer is made of silicone rubber or the like, and the release layer is made of fluorine-based resin or the like. The base layer may be formed in a three-layer structure of nickel (Ni), copper (Cu), and nickel, or may be formed in a single-layer structure of nickel or copper.

The pressing roller 42 is formed in a columnar shape, and presses the fixing belt 41 against the pad 46 from the outside. The pressing roller 42 is formed of a cylindrical core material 53 rotatable around a rotational axis C1, an elastic layer 54 provided on the outer circumference of the core material 53, and a release layer (not shown) covering the outer surface of the elastic layer 54, for example. The core material 53 is made of metal such as stainless steel or aluminum, the elastic layer 54 is made of silicone rubber or silicone sponge, and the release layer is made of a fluorine-based resin. A drive source 55 such as a motor is connected to the pressing roller 42.

The pad 46 is made of metal material such as aluminum alloy, and formed to have a long length. The pad 46 faces the pressing roller 42 across the fixing belt 41, and supports the fixing belt 41 from the inside along the conveyance path L1. The supporting surface 56 of the pad 46 is formed in a concave shape corresponding to the outer circumferential surface of the pressing roller 42. The supporting surface 56 of the pad 46 is slightly inclined from the upstream to the downstream (from the lower side to the upper side) of the conveyance path L1 so as to reduce the thickness of the pad 46. The fixing belt 41 is pressed against the supporting surface 56 of the pad 46 by the pressing roller 42, such that the fixing belt 41 is deformed in a concave shape following the supporting surface 56.

The guide plate 47 is made of a long metal thin plate such as a stainless steel plate, and formed to have a substantially circular arc-shaped cross section. The guide plate 47 guides the rotating of the fixing belt 41 from the inside on the side opposite to the pad 46 across the rotational axis C2. The temperature sensor 51 detects the temperature of the fixing belt 41 by bringing a detection element such as a thermistor into contact with the inner surface of the fixing belt 41. A power source 59 is connected to the heater 52, and a high frequency current is supplied from the power source 59 to the excitation coil of the heater 52. A magnetic flux is generated by energization of the excitation coil, and the magnetic flux is absorbed by the fixing belt 41, so that the fixing belt 41 is inductively heated.

In the fixing device 40, the pad is usually made of synthetic resin having a low thermal conductivity so that the heat is not taken from the fixing belt 41 to the pad. When the sheet is passed through the fixing device 40, the heat is taken from the sheet passing region at the center side in the width direction of the fixing belt 41 to the sheet, and the temperature of the non-sheet passing regions at both end sides in the width direction of the fixing belt 41 is relatively higher than that of the sheet passing region. Therefore, not only the sheet is curled, but also the non-sheet passing regions of the fixing belt 41 may be abnormally heated. Therefore, in the fixing device 40 of this embodiment, the metal pad 46 having a high thermal conductivity is used, so that the temperature distribution is made uniform in the width direction of the fixing belt 41.

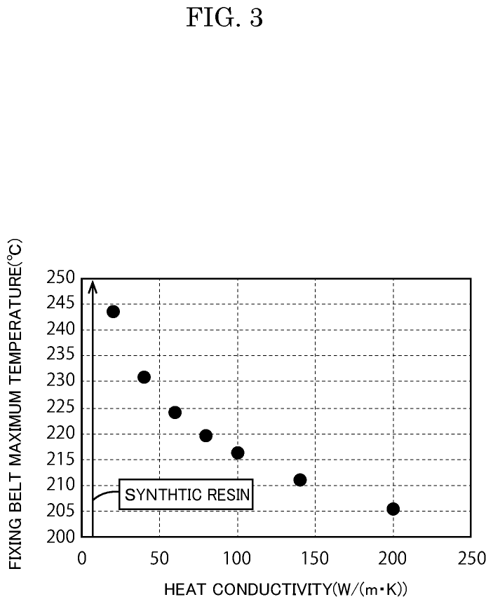

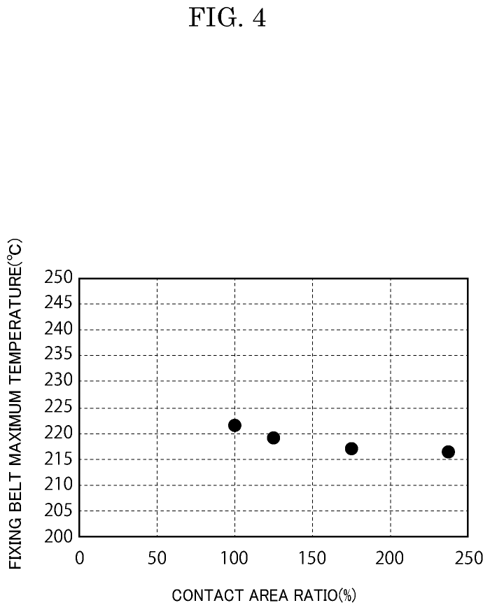

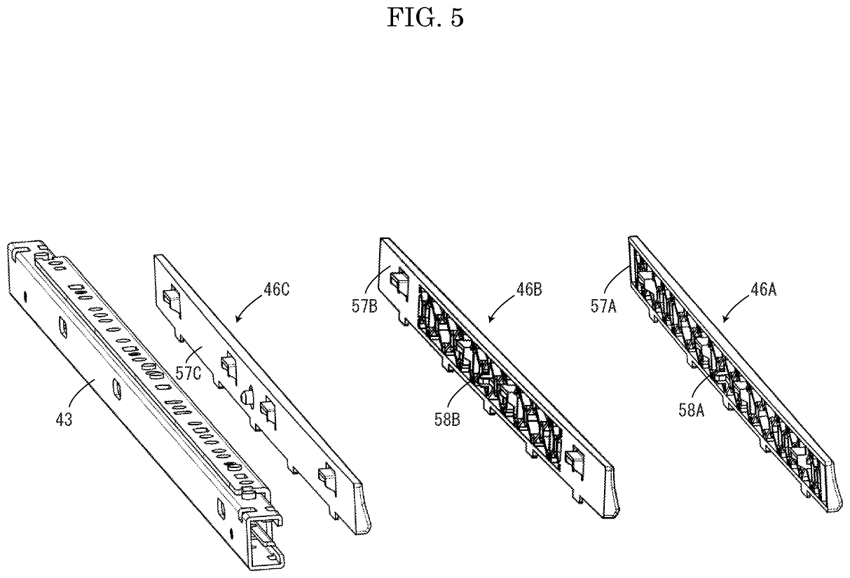

Hereinafter, with reference to FIG. 3 to FIG. 5, a material property of the pad and a contact area ratio of the pad to the stay will be described. FIG. 3 is a graph showing a relationship between a heat conductivity of the pad and a temperature of the fixing belt. FIG. 4 is a graph showing a relationship between a contact area ratio of the pad and a temperature of the fixing belt. FIG. 5 is a perspective view showing the pad and the stay of the present embodiment. In FIG. 3, the vertical axis indicates a maximum temperature of the fixing belt and the horizontal axis indicates a heat conductivity of the pad. In FIG. 4, the vertical axis indicates a maximum temperature of the fixing belt and the horizontal axis indicates a contact area ratio of the pad to the stay.

As shown in FIG. 3, a plurality of types of pads of different materials were prepared, and the temperature of the non-passing region of the fixing belt 41 was measured by a thermocouple at the point of saturation of continuous printing of the printer 1 under normal environment of a room temperature of 23° C. and a humidity of 50%. As a result, when the pad made of synthetic resin was used for the fixing device 40, the maximum temperature of the non-sheet passing region of the fixing belt 41 was excessively increased to 250° C. or more. In this case, the maximum temperature of the non-sheet passing region of the fixing belt 41 becomes 220° C. or more, which is an abnormal temperature, and a temperature difference between the sheet passing region and the non-sheet passing region of the fixing belt 41 increases, resulting in generating of the curling of the sheet.

When the pad having a heat conductivity of 75 W/(m·K) was used in the fixing device 40, the maximum temperature of the non-sheet passing region of the fixing belt 41 is suppressed to 220° C. or less. In this case, the excessive temperature increasing of the non-sheet passing region of the fixing belt 41 is suppressed, and the temperatures of the sheet passing region and the non-sheet passing region of the fixing belt 41 are uniformly made to close to each other to suppress the curling of the sheet. As described above, even if the base layer of the fixing belt 41 is made of metal whose temperature easily increases, the heat conductivity of the pad is made high, so that the heat is appropriately taken from the fixing belt 41 to the pa, and it becomes possible to appropriately increase the temperature of the fixing belt 41.

When the pad having a heat conductivity of 150 W/(m·K) was used in the fixing device 40, a maximum temperature of the non-sheet passing region of the fixing belt 41 is about 210° C. Further, when the pad having a heat conductivity of 200 W/(m·K) was used in the fixing device 40, a maximum temperature of the non-sheet passing region of the fixing belt 41 is about 205° C. If the heat conductivity of the pad is too high, a large amount of heat is taken from the fixing belt 41 to the pad, and the warm-up time of the fixing device 40 is prolonged. When the maximum temperature of the non-sheet passing region of the fixing belt 41 is about 205° C. or more, the temperature of the fixing belt 41 can be increased to a desired fixing temperature within a specified starting time.

Therefore, a heat conductivity of the pad is preferably 75 W/(m·K) or more and 200 W/(m·K) or less, and a heat conductivity of the pad is more preferably 75 W/(m·K) or more and 150 W/(m·K) or less. For example, an aluminum alloy of ADC 12 and A 5052 specified by JIS standard are used for the pad. The pad is not limited to an aluminum alloy, and may be made of another metal material such as copper or a material other than metal material. The plurality of types of pads shown in FIG. 3 have a contact area ratio of 95% of a contact surface in contact with the stay 43.

As shown in FIG. 4, a plurality of types of pads having different contact area ratios of the contact surface in contact with the stay 43 were prepared, and a temperature of the non-sheet passing region of the fixing belt 41 was measured by a thermocouple at the point of saturation of continuous printing of the printer 1 under normal environment of a room temperature 23° C. and a humidity 50%. As a result, when the pad having a contact area ratio of 40% was used in the fixing device 40, a maximum temperature of the non-sheet passing region of the fixing belt 41 is excessively increased to 220° C. or more. In this case, a maximum temperature of the non-sheet passing region of the fixing belt 41 becomes 220° C. or more, which is an abnormal temperature, and a temperature difference between the sheet passing region and the non-sheet passing region of the fixing belt 41 increases, resulting in generating of the curling of the sheet.

When the pad having a contact area ratio of 50% was used in the fixing device 40, a maximum temperature of the non-sheet passing region of the fixing belt 41 is suppressed to 215° C. or more and 220° C. or less. In this case, an excessive temperature increasing of the non-sheet passing region of the fixing belt 41 is suppressed, and the temperatures of the sheet passing region and the non-sheet passing region of the fixing belt 41 are uniformly made to close to each other. Further, the heat of the fixing belt 41 is not excessively taken by the pad. Even when the pad having a contact area ratio of 70% or 95% is used for the fixing device 40, the maximum temperature of the non-sheet passing region of the fixing belt 41 is suppressed to 215° C. or more and 220° C. or less. As described above, it is preferable that a contact area ratio of the contact surface of the pad in contact with the stay 43 is 50% or more. The aluminum alloy of ADC 12 is used for the plurality of types of pads shown in FIG. 4.

On the right side of FIG. 5, the pad 46A having a contact area ratio 40% of the contact surface 57A to the stay 43 is shown. The entire portion of the contact surface 57A of the pad 46A is formed of a rib 58A. In the center of FIG. 5, the pad 46B having a contact area ratio of 60% of the contact surface 57B to the stay 43 is shown. Both entire end portions of the contact surface 57B in the longitudinal direction are formed flat, and the entire center portion of the contact surface 57B in the longitudinal direction is formed of ribs 58B. On the left side of FIG. 5, the pad 46C having a contact area ratio of 95% of the contact surface 57C to the stay 43 is shown. The entire contact surface 57C of the pad 46C is formed flat.

In view of prevention of excessive temperature increasing and shortening of warm-up time, it is preferable to employ the pad 46B. In the contact surface 57B of the pad 46B in contact with the stay 43, the contact area ratio on the center side in the longitudinal direction is formed smaller than the contact area ratio on both end sides in the longitudinal direction. Both the end sides of the contact surface 57B in the longitudinal direction correspond to the non-sheet passing region sides of the fixing belt 41, and the center side of the contact surface 57B in the longitudinal direction corresponds to the sheet passing region side of the fixing belt 41. Although the heat is taken from the sheet passing regions of the fixing belt 41 to the sheet, the heat is easily transmitted from the non-sheet passing region of the fixing belt 41 to the stay 43 via both the end portions of the pad 46B in the longitudinal direction, and a temperature distribution becomes uniform in the width direction of the fixing belt 41.

As described above, according to the present embodiment, since the metal pad 46 is brought into contact with the inner surface of the fixing belt 41 in the width direction, the heat is taken from the fixing belt 41 to the metal pad 46, and a temperature distribution becomes uniform in the width direction of the fixing belt 41. Therefore, the excessive temperature increasing of the non-sheet passing regions of the fixing belt 41 is prevented, and a temperature difference between the sheet passing region and the non-sheet passing region of the fixing belt 41 is decreased. Therefore, the curling of the sheet can be suppressed without lowering productivity of the sheet.

Further, by adopting the fixing device 40 of this embodiment to the printer 1 (see FIG. 1), even if the number of sheets to be processed increases, it is not necessary to increase the cooling air by the fan.

Although the heater heats the fixing belt from the outside in this embodiment, the heater may heat the fixing belt from the inside. Further, as long as the heater can heat the fixing belt in the width direction, a heating system other than the IH system may be adopted.

Further, in the present embodiment, the stay is formed by two members of the center frame and the auxiliary frame, but the stay may be formed by two or more members or the stay may be formed by one member.

In the present embodiment, a printer is shown as an example of the image forming apparatus, but the present invention is not limited to this configuration. The image forming apparatus may be a multifunction peripheral having a printing function, a copying function, a facsimile function, or the like in combination, in addition to a copying machine and a facsimile machine.

Further, in the present embodiment, the sheet may be in the form of a sheet on which an image is to be formed, and may be a plain paper, a coated paper, a tracing paper, or an OHP (Over Head Projector) sheet, for example.

Although the present embodiment has been described, as another embodiment, the above-described embodiment and the modified embodiment may be wholly or partially combined.

The techniques of the present disclosure are not limited to the embodiments described above, and may be changed, replaced, or modified in various ways without departing from the spirit of the technical philosophy. Further, if the technical idea can be realized in another way by the progress of the technology or another technique derived from the technology, the method may be used. Accordingly, the claims cover all embodiments that may be included within the scope of the technical idea.

1. A fixing device comprising:
an endless fixing belt rotating as a sheet is conveyed;
a heater which heats the fixing belt in a width direction;
a pad coming into contact with an inner surface of the fixing belt in the width direction;
a stay which supports the pad inside the fixing belt; and
a pressing roller which presses the fixing belt against the pad, wherein
the pad is made of metal.

2. The fixing device according to claim 1, wherein
the pad has a heat conductivity of 75 W/(m·K) or more to 200 W/(m·K) or less.

3. The fixing device according to claim 1, wherein
a contact area ratio of a contact surface of the pad to the stay is 50% or more.

4. The fixing device according to claim 3, wherein
the fixing belt has a sheet passing region on a center side in the width direction and non-sheet passing regions on both end sides in the width direction, and
the contact area ratio is smaller on a side of the sheet passing region than on sides of the non-sheet passing regions in the contact surface of the pad to the stay.

5. The fixing device according to claim 3, wherein
the contact surface of the pad to the stay has a rib structure.

6. The fixing device according to claim 1, wherein
the fixing bels has a base layer made of metal.

7. An image forming apparatus comprising:
an image forming unit which forms a toner image on a sheet; and
the fixing device according to claim 1.
